(19) United States
(12) Patent Application Publication
(10) Pub. No.: US 2026/0301199 A1
(43) Pub. Date: Oct. 1, 2026

(54) METHOD FOR PERFORMING THREE-DIMENSIONAL POSE RECONSTRUCTION UNDER OCCLUDED AND APPARATUS THEREOF

(71) Applicant: Industrial Technology Research Institute, Hsinchu (TW)

(72) Inventors: Wei-Chun Wang, Taipei City (TW); BoYang Chen, New Taipei City (TW); Shih-An Chen, Hsinchu City (TW); Hong-Dun Lin, Hsinchu City (TW)

(73) Assignee: Industrial Technology Research Institute, Hsinchu (TW)

(21) Appl. No.: 19/577,391

(22) Filed: Mar. 25, 2026

Related U.S. Application Data
(60) Provisional application No. 63/777,658, filed on Mar. 25, 2025.

(51) Int. Cl. G06T 7/246; G06V 10/26; G06V 10/70; G06V 10/72; G06V 10/764; G06V 10/82; G06V 40/20

(52) U.S. Cl. CPC G06T 7/251; G06V 10/273; G06V 10/72; G06V 10/764; G06V 10/87; G06V 40/20; G06T 2207/20081; G06T 2207/20084; G06T 2207/30196; G06V 10/82

(57) ABSTRACT

A method for performing three-dimensional pose reconstruction under occluded and apparatus thereof is provided. The method comprises: capturing an image including a target object via a camera, wherein at least a portion of the target object in the image is occluded; performing image preprocessing on the image; estimating two-dimensional joints of the target object from the preprocessed image using a skeleton estimation model; determining a specific motion of the target object based on the two-dimensional joints; selecting a trained generative model according to the specific motion, and executing the trained generative model via a processor to generate predicted two-dimensional joints corresponding to the occluded portions of the target object, wherein the trained generative model is trained by using non-occluded images of the target object performing the specific motion; and performing three-dimensional pose reconstruction via the processor on the two-dimensional joints and the predicted two-dimensional joints to obtain three-dimensional joints.

### CROSS-REFERENCE TO RELATED APPLICATION

This application claims the priority benefit of U.S. provisional application Ser. No. 63/777,658, filed on Mar. 25, 2025. The entirety of each of the above-mentioned patent applications is hereby incorporated by reference herein and made a part of this specification.

### BACKGROUND

### Technical Field

The disclosure relates to a method and apparatus for three-dimensional pose reconstruction, and particularly relates to a method for performing three-dimensional pose reconstruction under occluded and apparatus thereof.

### Description of Related Art

Human pose estimation has become a fundamental technology in a wide range of application fields, with applications including motion capture, performing arts, human-machine interaction, motion analysis, and virtual reality experiences in the entertainment industry. In such applications, accurately extracting the spatial positions of the target object's body joints is crucial for driving realistic animations of virtual characters, which are commonly referred to as avatars. In real-time performance scenarios, such as musical instrument performance, conducting, and dance performance, continuous and precise tracking of the performer's body movements is required to generate convincing virtual character motions that allow audiences to interact in real time.

Some human pose estimation methods rely on estimating two-dimensional joint coordinates from a single image and employ depth sensing hardware, such as time-of-flight sensors or structured light projectors, to directly obtain three-dimensional spatial information. Additionally, some methods utilize Inertial Measurement Unit (IMU) worn on the performer's body to extract motion data, making them unaffected by visual limitations.

However, the methods above still have significant limitations in actual deployment scenarios. Methods based on wearable sensors impose physical restrictions on performers, may interfere with natural movements, and require relatively cumbersome setup procedures. When using single-viewpoint cameras, occlusion remains a challenge: when parts of the target object's body are occluded from the camera's line of sight, such as being occluded by instruments, stage equipment, other limbs, or the human body, the corresponding joint positions cannot be directly observed, leading to incomplete skeleton reconstruction or errors. Some methods attempt to handle partial occlusion situations through interpolation or heuristic compensation, but such techniques often generate physically unreasonable joint trajectories, temporal jitter, and motion artifacts, thereby reducing the quality of subsequent virtual character animations and making them unsuitable for real-time applications, especially when deployed on resource-constrained edge computing platforms rather than cloud infrastructure.

### SUMMARY

The disclosure provides a method and apparatus for performing three-dimensional pose reconstruction under occluded, accurately predicting the positions of occluded joints even when significant parts of the target object's body are occluded.

A method for performing three-dimensional pose reconstruction under occluded according to the disclosure comprises the following steps: obtaining an image including an object through a camera, wherein at least a part of the object in the image is occluded; performing image preprocessing on the image; estimating a plurality of two-dimensional joints of the object based on a skeleton estimation model and the preprocessed image; determining a specific motion of the object based on the two-dimensional joints; selecting a trained generative model according to the specific motion, executing the trained generative model to generate a plurality of predicted two-dimensional joints corresponding to the occluded part of the object, wherein the trained generative model is trained using non-occluded images of the specific motion of the object; and performing three-dimensional pose reconstruction on the plurality of two-dimensional joints and the plurality of predicted two-dimensional joints to obtain a plurality of three-dimensional joints.

An apparatus for performing three-dimensional pose reconstruction under occluded according to the disclosure comprises a camera and an edge computing device communicatively connected to the camera. The camera is configured to obtain an image including an object, wherein at least a part of the object in the image is occluded. The edge computing device comprises a processor and a memory electrically connected to the processor, the memory is configured to store instructions, when the instructions are executed by the processor, the processor is caused to perform the following operations: perform image preprocessing on the image; estimate a plurality of two-dimensional joints of the object based on a skeleton estimation model and the preprocessed image; determine a specific motion of the object based on the plurality of two-dimensional joints; select a trained generative model according to the specific motion, execute the trained generative model through the processor to generate a plurality of predicted two-dimensional joints corresponding to occluded part of the object, wherein the trained generative model is trained using non-occluded images of the specific motion of the object; perform three-dimensional pose reconstruction on the plurality of two-dimensional joints and the plurality of predicted two-dimensional joints to obtain a plurality of three-dimensional joints.

Based on the above, the disclosure provides a method and apparatus for performing three-dimensional pose reconstruction under occluded, utilizing non-occluded images to train generative models corresponding to specific motions of each motion category, even in the case of a single viewpoint and significant parts of the object's body being occluded, still being able to accurately predict and generate positions of occluded joints, and reconstruct complete three-dimensional joints of the human body skeleton, producing temporally smooth and physically reasonable motion outputs, effectively eliminating jitter or unreasonable distortion caused by occlusion, requiring only a single camera and edge computing device to achieve motion capture.

Several exemplary embodiments accompanied with figures are described in detail below to further describe the disclosure in details.

### BRIEF DESCRIPTION OF THE DRAWINGS

FIG. 1 is a schematic diagram of an apparatus for performing three-dimensional pose reconstruction under occluded according to an embodiment of the disclosure.

FIG. 2 is a schematic diagram of a detailed structure of an apparatus according to an embodiment of the disclosure.

FIG. 3 is a schematic diagram of cropping an object bounding box from an image according to an embodiment of the disclosure.

FIG. 4 is a schematic diagram of estimating each two-dimensional joint of an object in an object bounding box according to an embodiment of the disclosure.

FIG. 5 is a schematic diagram of reconstructed three-dimensional joints after filtering according to an embodiment of the disclosure.

FIG. 6 is a flowchart of a method for performing three-dimensional pose reconstruction under occluded according to an embodiment of the disclosure.

### DESCRIPTION OF THE EMBODIMENTS

Some exemplary embodiments of the disclosure will now be described in detail with reference to the accompanying drawings. In the following description, when the same reference numerals appear in different drawings, the reference numerals will be regarded as the same or similar components. The exemplary embodiments are merely a part of the disclosure and do not disclose all possible implementations of the disclosure. More precisely, the exemplary embodiments are merely examples of the methods, devices, and systems in the appended claims of the disclosure.

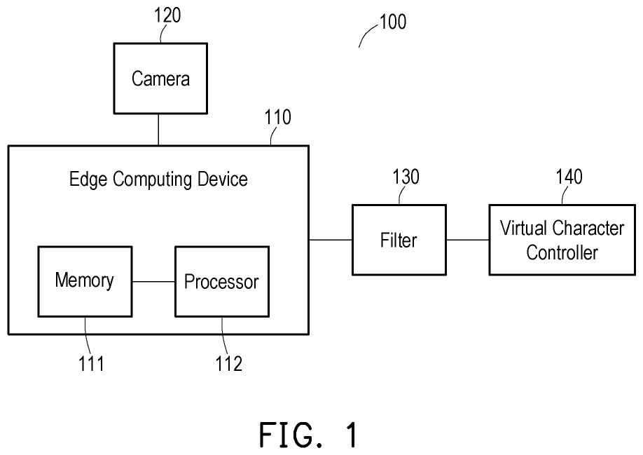

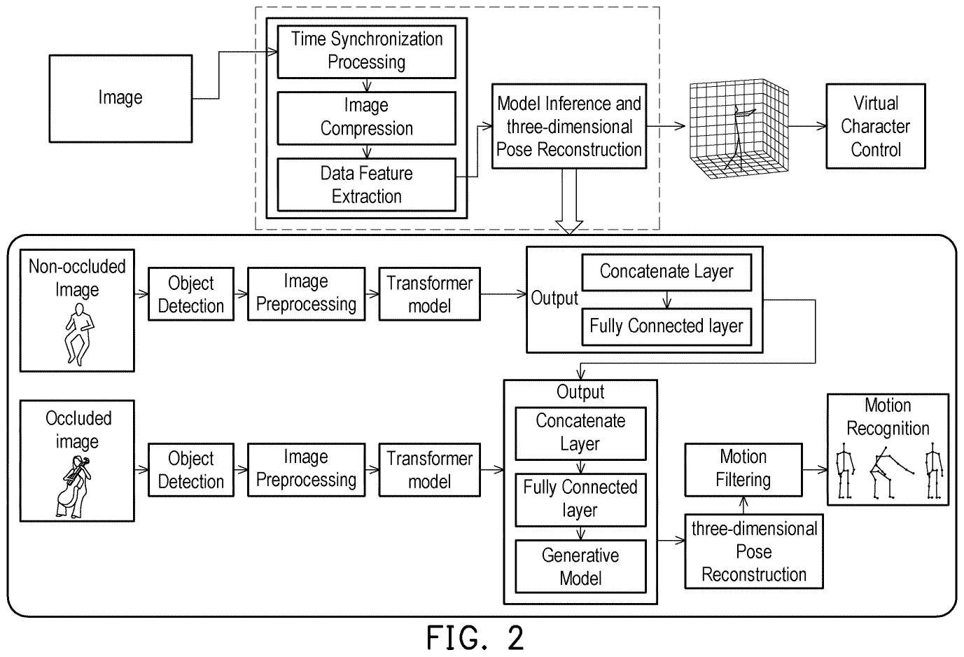

FIG. 1 is a schematic diagram of an apparatus for performing three-dimensional pose reconstruction under occluded according to an embodiment of the disclosure. FIG. 2 is a schematic diagram of a detailed structure of an apparatus according to an embodiment of the disclosure. Firstly, FIG. 1 and FIG. 2 introduce various components and configuration relationships in the apparatus, and the detailed functions will be disclosed together with the schematic diagrams of subsequent example embodiments.

Referring to FIG. 1 and FIG. 2, the apparatus 100 for performing three-dimensional pose reconstruction under occluded comprises an edge computing device 110, a camera 120, a filter 130, and a virtual character controller 140. The apparatus 100 is designed to solve when the camera 120 obtains images from a single viewpoint, a part of the object's body may be occluded by instruments, equipment, other limbs, or the human body in the image, and still accurately predict and generate joint positions of the occluded joints, and reconstruct complete three-dimensional joints of the human body skeleton.

The camera 120 may adopt a single-viewpoint camera or other similar components, the camera 120 may provide high-resolution images, which means the camera 120 may have a function of capturing images. The camera 120 is configured to obtain images, which is, for example, a camera lens with a lens element and a photosensitive component. The photosensitive component is configured to sense the intensity of light entering the lens element, thereby generating an image. The photosensitive component may be, for example, a charge coupled device (CCD), a complementary metal-oxide semiconductor (CMOS) component, or other similar components.

The camera 120 is configured to obtain images including an object, in an exemplary embodiment, the images may comprise occluded images which at least a part of the object is occluded and non-occluded images which the object is not occluded, wherein the non-occluded images are images obtained by the camera when the object performs specific motions when the object is not occluded. In different embodiments, the images may be a frame image or continuous frame image sequences including the object obtained through the camera 120, or a frame image or continuous frame image sequences including the object obtained through the camera 120 taken from any database, the disclosure is not limited thereto.

The edge computing device 110 may be communicatively connected to the camera 120 and the filter 130 respectively in a wireless or wired manner, the edge computing device 110 may comprise a processor 112 and a memory 111, the memory 111 is electrically connected to the processor 112. The memory 111 may be, for example, any type of fixed or removable random access memory (RAM), read-only memory (ROM), flash memory, hard disk or other similar devices, integrated circuits, or combinations thereof, and may record a plurality of program codes or instructions.

The processor 112 may be a general purpose processor, a special purpose processor, a conventional processor, a digital signal processor (DSP), a plurality of microprocessors, one or more microprocessors combined with a digital signal processor core, a controller, a microcontroller, an Application Specific Integrated Circuit (ASIC), a Field Programmable Gate Array (FPGA), any other type of integrated circuit, a state machine, an Advanced RISC Machine (ARM)-based processor, or the like.

The edge computing device 110 may perform image preprocessing on the images obtained by the camera 120, and execute model inference and three-dimensional pose reconstruction, to execute the program codes or instructions stored in the memory 111 to implement the method for performing three-dimensional pose reconstruction under occluded in the example embodiments of the present disclosure, the details of which are described in detail as follows.

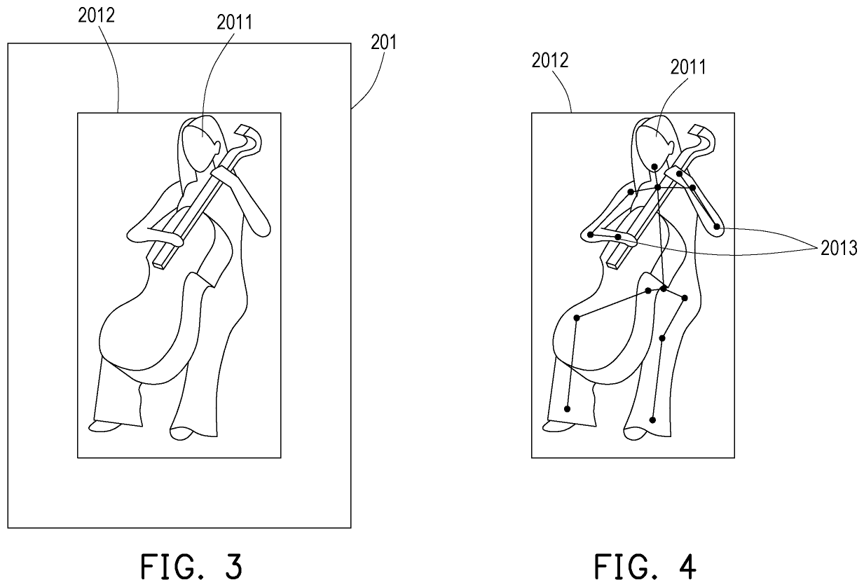

FIG. 3 is a schematic diagram of cropping an object bounding box from an image according to an embodiment of the disclosure. FIG. 4 is a schematic diagram of estimating each two-dimensional joint of an object in an object bounding box according to an embodiment of the disclosure.

Referring to FIG. 2 to FIG. 4, in an exemplary embodiment, after obtaining continuous frame images including an object through the camera 120 such as a single viewpoint camera, the processor 112 may perform image preprocessing on each frame image 201 in the continuous frames obtained by the camera 120. In the present embodiment, an example is provided in which a large instrument (such as a cello) occludes lower body joints, such that the apparatus 100 cannot detect the corresponding joints.

Firstly, the processor 112 may perform object detection on the frame image 201 obtained by the camera 120 based on a deep learning object detection model and crop an object bounding box 2012 including an object 2011 from the frame image 201, to reduce unnecessary background image information other than the object, effectively reduce computational load and improve the accuracy of subsequent skeleton estimation. In the present embodiment, the object detection model may be, for example, a YOLOv5 model for detecting object bounding box in the image, and may output object bounding boxes, motion categories of objects, and confidence scores.

Next, the processor 112 may perform image preprocessing such as temporal synchronization processing, image compression, and data feature extraction on the image or image sequence to generate input data for model inference.

Thereafter, the processor 112 may use a skeleton estimation model such as High-Resolution Net (HRNet) to perform two-dimensional skeleton inference, to identify each two-dimensional joint 2013 of the object 2011 in the object bounding box 2012 and coordinates corresponding to each two-dimensional joint 2013.

In detail, the processor 112 may use the self-attention mechanism of a Transformer model based on the coordinates corresponding to each two-dimensional joint 2013, combine the spatial coordinate information and temporal information of each two-dimensional joint 2013, and generate and obtain feature vectors of each two-dimensional joint 2013 at different time points.

In an example embodiment, the Transformer model may learn the correlation of the same two-dimensional joint at different time points in the temporal dimension, and learn the correlation between different two-dimensional joints in the spatial dimension, thereby obtaining the temporal variation patterns of each two-dimensional joint.

Thereafter, the processor 112 performs feature fusion of the spatial feature information, temporal feature information, and feature vectors of each two-dimensional joint at each time point, and obtain the position or coordinates of each two-dimensional joint of the object through the skeleton estimation model.

In further detail, the processor 112 may, based on a Transformer model (which may include a Spatial-aware transformer and a Temporal-aware transformer), perform feature fusion of the spatial feature information, temporal feature information, and feature vectors of each two-dimensional joint at each time point, perform feature concatenation through a Concatenate Layer, and perform model inference through a Fully Connected layer (FC layer) to obtain the position or coordinates of each two-dimensional joint of the human body skeleton of the object.

The processor 112 may extract the relative spatial relationships between each two-dimensional joint of the skeleton through the spatial-aware transformer, that is, perform feature fusion of the spatial feature information of each two-dimensional joint in terms of spatial relationships, and the processor 112 may perform feature fusion of the temporal feature information of the same two-dimensional joint and the feature vectors at different time points through the temporal-aware transformer, that is, perform feature fusion of the same two-dimensional joint in terms of temporal and spatial relationships, enabling the skeleton estimation model to learn the temporal variation of the motions of each two-dimensional joint on the skeleton, concatenate the feature-fused features through the feature concatenation layer, and then perform model inference through the fully connected layer to obtain the position or coordinates of each two-dimensional joint of the skeleton of the object.

In an example embodiment, the processor 112 may analyze the above-mentioned image-preprocessed image or image sequence (comprising non-occluded images or occluded images) through the skeleton estimation model, identify the positions of each two-dimensional joint of the object, and further infer the positions or coordinates of each two-dimensional joint for subsequent motion analysis.

Thereafter, the processor 112 may determine a specific motion of the object based on the positions of each two-dimensional joint of the object, the processor 112 may select a trained generative model corresponding to the motion category of the specific motion from the plurality of trained generative models according to the specific motion, and execute the trained generative model to generate positions or coordinates of the plurality of predicted two-dimensional joints corresponding to the occluded part of the object.

In an embodiment, the trained generative model is trained using non-occluded images of specific motions of the object, the trained generative model may comprise a plurality of trained generative models corresponding to specific motions of a plurality of motion categories, wherein the motion categories may comprise human movements within a relatively restricted range of motions, which may be, for example, musical instrument performance, conducting performance, etc. The disclosure is not limited thereto. The edge computing device 110 may pre-collect non-occluded images of specific motions of various motion categories (for example, motions which performers' limbs have reasonable positions such as cello playing, violin playing, etc.) to train the generative model, such that in motions of the category, even if part of the object's body is occluded, the trained generative model can still predict reasonable positions or coordinates of the two-dimensional joints of the occluded part of the object.

The processor 112 may perform three-dimensional pose reconstruction on the above-mentioned two-dimensional joints obtained through skeleton estimation model inference and the predicted two-dimensional joints generated via the trained generative model to obtain a plurality of three-dimensional joints.

In an embodiment, the processor 112 reconstructs the above-mentioned two-dimensional joints obtained through skeleton estimation model inference and the predicted two-dimensional joints into a plurality of candidate three-dimensional joints P^{N} through a triangulation method of multi-viewpoint images, wherein

$$N = {C}_{2}^{m} = \frac{m ( m - 1 )}{2}$$

and m is the number of viewpoints, wherein each of candidate three-dimensional joints is obtained by performing triangulation on two-dimensional joints corresponding to any combination of two viewpoints.

The processor 112 obtains a plurality of weights corresponding to the candidate three-dimensional joints according to confidence scores of the two-dimensional joints corresponding to each viewpoint combination, performs weighted integration of the candidate three-dimensional joints based on the weights to obtain a plurality of most reliable three-dimensional joints.

In an embodiment, the most reliable three-dimensional joints may be obtained according to the following formula 1.

$$\hat{P} = \frac{{\sum }_{j = 1}^{n} {P}_{j}^{n} \times {S}_{j}^{n}}{{\sum }_{j = 1}^{n} {S}_{j}^{n}} \qquad Formula 1$$

Wherein, \hat{P} is the filtered most reliable three-dimensional joints,

$${S}_{j}^{n}$$

is the confidence score of the two-dimensional joints of the candidate three-dimensional joints,

$${P}_{j}^{n}$$

the three-dimensional joints reconstructed by the nth pair of cameras or the nth pair of viewpoint combinations, j represents the joints or two-dimensional joints of the object.

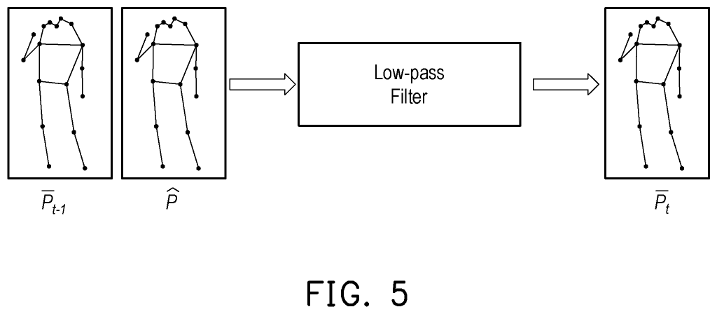

FIG. 5 is a schematic diagram of reconstructed three-dimensional joints after filtering according to an embodiment of the disclosure.

Referring to FIG. 5, wherein \hat{P} is the most reliable three-dimensional joints output after filtering, P̅ₜ₋₁ is the smoothing result of the previous frame, P̅ₜ is the smoothing result of the current frame.

The filter 130 is communicatively connected to the edge computing device 110, and is configured to filter the most reliable three-dimensional joints output by the edge computing device 110 to eliminate errors in three-dimensional pose reconstruction, and output three-dimensional joints that are temporally smooth and physically reasonable.

In the present embodiment, the filter 130 is a low-pass filter, which may set filter parameters of the low-pass filter according to movement characteristics of the most reliable three-dimensional joints to filter the most reliable three-dimensional joints and output the filtered three-dimensional joints. That is to say, the filter 130 may adjust different filter parameters for movement characteristics of different joints, allowing end joints with fast movements and core joints with slow movements to have different filtering effects.

In an embodiment, the most reliable three-dimensional joints may be, for example, joint points or end joints of a human body that are relatively sensitive to changes over time or have fast movements. The joint points or end joints of the human body may be, for example, wrists, ankles, fingers, etc. In another exemplary embodiment, the most reliable three-dimensional joints may be, for example, core joints of a human body that are relatively slow to changes over time or have slow movements, which may be, for example, hips, spine, shoulders. The disclosure is not limited thereto.

Therefore, in order to reduce jitter phenomena during slow movements while improving smoothness during fast movements, the filter 130 may adjust the filter parameters to relatively small parameters for end joints with fast movements, and may adjust the filter parameters to relatively large parameters for core joints with slow movements, performing different degrees of filtering on different joints, thereby solving the problem of unnatural joint movement and improving accuracy and application range.

The apparatus 100 for performing three-dimensional pose reconstruction under occluded may be applicable to motion capture equipment or animation production, etc. In an embodiment, the apparatus 100 may comprise a virtual character controller 140 for controlling virtual character motions. The virtual character controller 140 may be communicatively connected to the filter 130 in a wireless or wired manner. After identifying motion categories of the object from the three-dimensional joints output by the filter 130, the virtual character controller 140 may receive human body joint data output by the edge computing device 110 or the filter 130, convert the data into a virtual character model, and drive virtual character motions. The disclosure is not limited thereto.

The virtual character controller 140 may be implemented as a central processing unit (CPU), graphics processing unit (GPU), or embedded processor capable of executing character control algorithms, and a memory for storing instructions, character model data, human body joint data, etc.

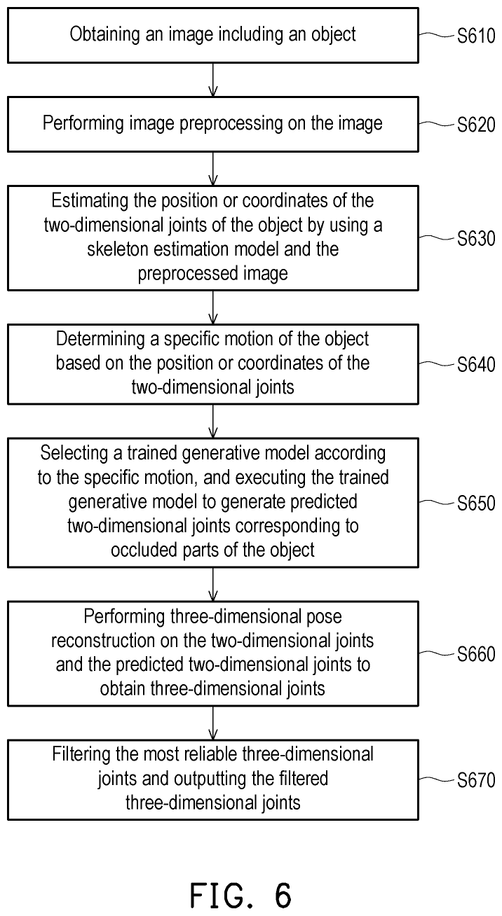

FIG. 6 is a flowchart of a method for performing three-dimensional pose reconstruction under occluded according to an embodiment of the disclosure. The method flow of FIG. 6 may be implemented by the structure or apparatus of FIG. 1 to FIG. 3.

Referring to FIG. 6, in step S610, a camera obtains an image including an object, wherein the camera 120 may adopt a single viewpoint camera, and at least a part of the object in the image is occluded. In an embodiment, the image may comprise an occluded image which at least a part of the object is occluded and a non-occluded image which the object is not occluded, wherein the non-occluded image is an image obtained by the camera when the object performs a specific motion under conditions where the object is not occluded.

In step S620, a processor performs image preprocessing on the image to generate input data for model inference.

In step S630, the processor estimates positions or coordinates of the plurality of two-dimensional joints of the object by a skeleton estimation model and the preprocessed image.

In step S640, the processor determines a specific motion of the object based on positions or coordinates of the two-dimensional joints.

In step S650, the processor selects a trained generative model according to the specific motion, and executes the trained generative model by the processor to generate a plurality of predicted two-dimensional joints corresponding to the occluded part of the object, wherein the trained generative model is trained using non-occluded images of the specific motion of the object.

In step S660, the processor performs three-dimensional pose reconstruction on the two-dimensional joints and the predicted two-dimensional joints to obtain a plurality of three-dimensional joints.

In step S670, a filter performs filtering on the most reliable three-dimensional joints and outputs the filtered three-dimensional joints.

In summary, the method and apparatus for performing three-dimensional pose reconstruction under occluded of the disclosure utilizes non-occluded images to train generative models corresponding to specific motions of each motion category, and is still capable of accurately predicting and generating positions of occluded joints and reconstructing three-dimensional joints of a complete human body skeleton even in a situation where a single viewpoint and a significant part of the object is occluded, generating temporally smooth and physically reasonable motion outputs, effectively eliminating jitter or unreasonable distortion caused by occlusion, and motion capture may be achieved with only a single camera and an edge computing device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for performing three-dimensional pose reconstruction under occluded, comprising:
obtaining an image including an object through a camera, wherein at least a part of the object in the image is occluded;
performing image preprocessing on the image;
estimating a plurality of two-dimensional joints of the object based on a skeleton estimation model and the preprocessed image;
determining a specific motion of the object based on the plurality of two-dimensional joints;
selecting a trained generative model according to the specific motion, executing the trained generative model to generate a plurality of predicted two-dimensional joints corresponding to occluded part of the object, wherein the trained generative model is trained using non-occluded images of the specific motion of the object; and
performing three-dimensional pose reconstruction on the plurality of two-dimensional joints and the plurality of predicted two-dimensional joints to obtain a plurality of three-dimensional joints.

2. The method according to claim 1, wherein the trained generative model comprises a plurality of trained generative models corresponding to specific motions of a plurality of motion categories, wherein the step of selecting the trained generative model according to the specific motion comprises selecting the trained generative model corresponding to the motion category of the specific motion from the trained generative models according to the specific motion.

3. The method according to claim 1, wherein the non-occluded images comprise images obtained by the camera when the object performs the specific motion under conditions where the object is not occluded.

4. The method according to claim 1, wherein the step of performing three-dimensional pose reconstruction on the plurality of two-dimensional joints and the plurality of predicted two-dimensional joints to obtain the plurality of three-dimensional joints further comprises:
reconstructing the plurality of two-dimensional joints and the plurality of predicted two-dimensional joints into a plurality of candidate three-dimensional joints P^{N} through a triangulation method of multi-viewpoint images, wherein
$$N = {C}_{2}^{m} = \frac{m ( m - 1 )}{2}$$
and m is number of viewpoints, wherein each of the candidate three-dimensional joints is obtained by performing triangulation on two-dimensional joints corresponding to any combination of two viewpoints; and
obtaining a plurality of weights corresponding to the plurality of candidate three-dimensional joints according to confidence scores of the two-dimensional joints corresponding to each of a viewpoint combination, performing weighted integration on the plurality of candidate three-dimensional joints according to the plurality of weights to obtain a plurality of most reliable three-dimensional joints.

5. The method according to claim 4, wherein the method further comprises:
performing filtering on the plurality of most reliable three-dimensional joints through a filter and outputting a plurality of filtered three-dimensional joints, wherein setting filter parameters of the filter according to movement characteristics of the plurality of most reliable three-dimensional joints.

6. The method according to claim 5, wherein the step of setting filter parameters of the filter according to movement characteristics of the plurality of most reliable three-dimensional joints further comprises:
adjusting the filter parameters to relatively small parameters for end joints with fast movement of the plurality of most reliable three-dimensional joints;
adjusting the filter parameters to relatively large parameters for core joints with slow movement of the plurality of most reliable three-dimensional joints.

7. An apparatus for performing three-dimensional pose reconstruction under occluded, comprising:
a camera configured to obtain an image including an object, wherein at least a part of the object in the image is occluded; and
an edge computing device communicatively connected to the camera, the edge computing device comprising a processor and a memory electrically connected to the processor, the memory configured to store instructions that, when executed by the processor, cause the processor to:
perform image preprocessing on the image;
estimate a plurality of two-dimensional joints of the object based on a skeleton estimation model and the preprocessed image;
determine a specific motion of the object based on the plurality of two-dimensional joints;
select a trained generative model according to the specific motion, execute the trained generative model through the processor to generate a plurality of predicted two-dimensional joints corresponding to occluded part of the object, wherein the trained generative model is trained using non-occluded images of the specific motion of the object; and
perform three-dimensional pose reconstruction on the plurality of two-dimensional joints and the plurality of predicted two-dimensional joints to obtain a plurality of three-dimensional joints.

8. The apparatus according to claim 7, wherein the trained generative model comprises a plurality of trained generative models corresponding to specific motions of a plurality of motion categories, wherein the operation of the processor selecting the trained generative model according to the specific motion comprises the processor selecting the trained generative model corresponding to the motion category of the specific motion from the trained generative models according to the specific motion.

9. The apparatus according to claim 7, wherein the non-occluded images comprise images obtained by the camera when the object performs the specific motion under conditions where the object is not occluded.

10. The apparatus according to claim 7, wherein the operation of the processor performing three-dimensional pose reconstruction on the plurality of two-dimensional joints and the plurality of predicted two-dimensional joints to obtain the plurality of three-dimensional joints further comprises:
the processor further configured to reconstruct the plurality of two-dimensional joints and the plurality of predicted two-dimensional joints into a plurality of candidate three-dimensional joints P^{N} through a triangulation method of multi-viewpoint images, wherein
$$N = {C}_{2}^{m} = \frac{m ( m - 1 )}{2}$$
and m is the number of viewpoints, wherein each of candidate three-dimensional joints is obtained by performing triangulation on two-dimensional joints corresponding to any combination of two viewpoints; and
the processor further configured to obtain a plurality of weights corresponding to the plurality of candidate three-dimensional joints according to confidence scores of the two-dimensional joints corresponding to each viewpoint combination, perform weighted integration on the plurality of candidate three-dimensional joints according to the plurality of weights to obtain a plurality of most reliable three-dimensional joints.

11. The apparatus according to claim 10, wherein the apparatus further comprises a filter electrically connected to the edge computing device, the filter configured to perform filtering on the plurality of most reliable three-dimensional joints and output a plurality of filtered three-dimensional joints, wherein the filter configured to set filter parameters of the filter according to movement characteristics of the plurality of most reliable three-dimensional joints.

12. The apparatus according to claim 10, wherein the filter further configured to adjust the filter parameters to relatively small parameters for end joints with fast movement of the plurality of most reliable three-dimensional joints and to adjust the filter parameters to relatively large parameters for core joints with slow movement of the plurality of most reliable three-dimensional joints.
